(19) United States
(12) Patent Application Publication
(10) Pub. No.: US 2014/0222716 A1
(43) Pub. Date: Aug. 7, 2014

(54) Methods And Systems For Processing Debt Portfolios

(71) Applicant: Michael A. Joplin, El Cajon, CA (US)

(72) Inventor: Michael A. Joplin, El Cajon, CA (US)

(21) Appl. No.: 14/169,819

(22) Filed: Jan. 31, 2014

Related U.S. Application Data
(60) Provisional application No. 61/759,551, filed on Feb. 1, 2013.

(51) Int. Cl. G06Q 40/06; G06Q 10/06

(52) U.S. Cl. CPC G06Q 40/06; G06Q 10/063
USPC 705/36 R

(57) ABSTRACT

Disclosed herein are systems and methods for forming an organization. Also disclosed herein are systems and methods for evaluating a debt portfolio. An exemplary method can comprise receiving a debt portfolio having a plurality of accounts. The method can comprise identifying predictive data for one or more of the plurality of accounts. The method can also comprise comparing one or more accounts in the debt portfolio to one or more accounts in a debt collection history based on the predictive data. The method can further comprise determining a predicted collection value based on the comparing the one or more accounts in the debt portfolio to the one or more accounts in the debt collection history.

### CROSS REFERENCE TO RELATED PATENT APPLICATION

This application claims priority to U.S. Provisional Application No. 61/759,551 filed Feb. 1, 2013, herein incorporated by reference in its entirety.

### BACKGROUND

Businesses sometimes have problems with customers who are delinquent in paying off debt. Accounts that remain overdue for a lengthy period of time may be designated as a charged-off account. Although the business may cease collection attempts, the business still would like to recover payment for the charged-off accounts.

### SUMMARY

It is to be understood that both the following general description and the following detailed description are exemplary and explanatory only and are not restrictive, as claimed. Provided are methods and systems for Processing Debt portfolios. An example method can comprise transferring legal title (e.g., right, title, interest), collection responsibility, and/or data of a charged off debt portfolio from a first organization to a second organization. The debt portfolio can comprise a plurality of debt accounts. The first organization can claim an equity share in the second organization as a positive financial asset. The worth of the debt portfolio can be evaluated according to a valuation scheme. A collection plan can be created based on the evaluation. Collection activities can be performed according to the collection plan resulting in collected funds. At least a portion of the collected funds can be provided to the first organization as income to the first organization.

In another aspect, an example method can comprise receiving a debt portfolio having a plurality of accounts. Predictive data can be identified for one or more of the plurality of accounts. One or more accounts in the debt portfolio can be compared to one or more accounts in a debt collection history based on the predictive data. A predicted collection value can be determined based on comparing the one or more accounts in the debt portfolio to the one or more accounts in the debt collection history.

In one aspect, an example system can comprise a memory having computer-executable instructions encoded thereon, and at least one processor functionally coupled to the memory and configured, by the computer-executable instructions, for receiving information of a debt portfolio from a first organization for a second organization (e.g., the information can comprise account data for a plurality of accounts of the debt portfolio), evaluating the worth of the debt portfolio according to a valuation scheme, generating a collection plan based on the evaluation, receiving collection data indicative of funds collected by the second organization according to the collection plan, and providing an instruction to transfer at least a portion of the funds collected by the second organization to the first organization as income to the first organization.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is a block diagram of a system suitable for implementing an aspect of the technology described herein;

FIG. 2 is a flowchart illustrating a method for processing debt portfolios;

FIG. 3 is a flowchart illustrating another method for processing debt portfolios; and

FIG. 4 is a block diagram illustrating an example computing system in which the present methods and systems can operate.

### DETAILED DESCRIPTION

Before the present methods and systems are disclosed and described, it is to be understood that the methods and systems are not limited to specific methods, specific components, or to particular configurations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

The present methods and systems are related to processing data for debt portfolios, such as charged off debt portfolios. For example, the present methods and systems can be implemented by the formation of an organization, such as a credit union servicing organization. The organization can receive legal right to a debt portfolio from a member of the organization, such as a credit union or other financial institution. The organization or a member thereof can evaluate the debt portfolio and create a plan for collecting on or more debt accounts. The plan can be based on a variety of information, such as prior collection history, social media information, credit information, and/or the like. The organization or member can collect money for a debt portfolio. Then, the organization can pay collected money to one or more members of the organization. The one or more members receiving the collected funds can receive the funds as positive income.

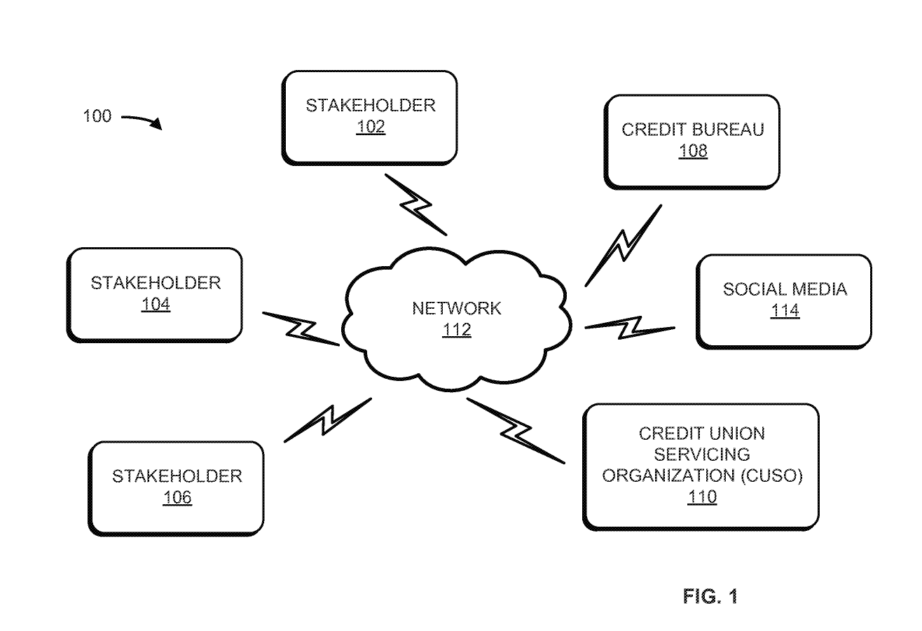

FIG. 1 is a block diagram illustrating an example system 100 for processing debt portfolios. The illustrated system 100 can comprise one or more stakeholders 102, 104, and 106. The system 100 can comprise one or more credit bureaus 108. The system 100 can comprise one or more credit union servicing organizations (CUSO) 110. The system 100 can comprise a network 112. The system 100 can comprise social media 114. It should be noted that though FIG. 1 illustrates organizations and/or parties, it should be understood that each of the organizations and/or parties can manage one or more devices, such as servers and other devices, to store and process data collected by and/or exchanged between the parties and/or organizations.

In one aspect, an example stakeholder 102, 104, and 106 can comprise a federal credit union, state credit union, financial institution, or other organization that has an equity share in the CUSO 110. The stakeholders 102, 104, and/or 106 can lend money to account holders. The stakeholders 102, 104, and/or 106 can manage (e.g., collect payments on) the debts on account holders. In one aspect, the stakeholders 102, 104, and/or 106 can have legal title (e.g., right, title, interest), and/or collection responsibility for one or more debt portfolios. The debt portfolios can comprise one or more accounts that have been charged off or deemed non-performing. For example, the debt portfolio can be deemed non-performing because the debtor has failed to make payments for a period of time. As an illustration, a charged off account can be a debt account deemed as uncollectable for accounting purposes. The debt portfolio also can be assigned or otherwise be associated with a worth or value. In one aspect, one or more of the stakeholders 102, 104, 106 can be associated with a corresponding device (e.g. computing device) managed by the stakeholder. For example, one or more stakeholders 102, 104, 106 can manage a corresponding server for processing data, such as user account information. The user account information can comprise loan information, such as name, address history, social security number, current and previous credit scores, prior credit bureau reports, copies of the original credit agreement, employment status and information, loan terms, loan balance, any accrued interest, loan payment history, commentary detail of prior conversations, debtor dispute notices, Service Members Credit Relief Act status, cell phone flag, bankruptcy and deceased warning flags, Do Not Call notice activity, and/or the like.

In one aspect, a device managed by a stakeholder 102, 104, 106 can be configured to provide user account information to a device managed by the CUSO 110. For example, the device managed by a stakeholder 102, 104, 106 can be configured to organize user account information as a debt portfolio. The device managed by a stakeholder 102, 104, 106 can provide the user account information as a debt portfolio to a device (e.g., computing device) managed by a CUSO 110. In one aspect, the user account information can be organized as a debt portfolio and transferred to a device managed by a CUSO 110. Such transfer can be associated with (e.g., triggered by, accompanied by) a transfer of legal title of the accounts in the debt portfolio to the CUSO 110.

In one aspect, the device managed by a stakeholder 102, 104, 106 can be configured to modify and/or update accounting information. Accounting information can comprise, for example, the status of a user account. Example statuses can comprise current (e.g. all payments are current), delinquent (e.g., at least one payment is late), charged off (e.g., not likely to receive further payment), and/or the like.

In one aspect, one or more of the stakeholders 102, 104, 106 can be a debt collection partner stakeholder. The debt collection partner stakeholder can be assigned to manage debt collection of one or more debt portfolios, such as debt portfolio having a legal title that has been transferred to the CUSO 110. In one aspect, the debt collection partner stakeholder can manage a debt collection management device (e.g., computing device) configured to process account information and other data of a plurality of debt portfolios. For example, the debt collection management device can receive user account information for a debt portfolio from a device managed by a stakeholder 102, 104, 106, a device managed by the CUSO 110, and/or the like. In one aspect, the debt collection management device can be configured to analyze the value of a debt portfolio, generate collection plans for the debt portfolio, and transfer information relevant to collection between one or more stakeholders 102, 104, 106, the CUSO 110, and/or other entity. As a further example, the debt collection management device can be configured to perform at least a part of one or more of the methods described herein.

In one aspect, a credit bureau 108 can comprise a consumer reporting agency, a credit reference agency, or other company that collects information from various sources and provides consumer credit information on individual consumers (e.g., debtors) for a variety of uses. In one aspect, the credit bureau 108 can manage a device (e.g., computing device), such as a server, configured to store and/or process the information collected by the credit bureau 108. The credit bureau 108 also can update the consumer credit information as appropriate. For example, the device managed by the credit bureau 108 can update the consumer credit information after new information is received from a source (e.g., a bank, creditor). In one aspect, the device managed by the credit bureau 108 can be configured to provide the consumer credit information to other devices, such as a device managed by a stakeholder 102, 104, 106, the debt collection management device, and/or device managed by the CUSO 110. As an illustration, the credit bureau 108 can provide information, such as a credit report, on the borrowing and bill-paying habits of consumers. Information provided by the credit bureau 108 can be used (e.g., by a device managed by a stakeholder and/or managed by CUSO) to predict the future behavior of a consumer (e.g., predictive data), identify ways to contact the consumer, and/or the like. For example, the information provided by the credit bureau 108 can be used (e.g. by the debt collection management device) to predict an amount of money collectable over a time period, a probability of collecting some or all of the debt of a consumer, and/or the like. As another example, the information from the credit bureau 108 can be used (e.g., by the debt collection management device to determine one or more methodologies for collecting on a debt account.

In one aspect, the credit union servicing organization (CUSO) 110 can be a financial service organization created by the stakeholders 102, 104, and/or 106 to perform services for the stakeholders 102, 104, and/or 106. Such services can comprise debt collection, credit rehabilitation, financial literacy education, refinancing of the charged off accounts(s) into new performing loans, reopening share accounts, and issuing check and debit cards to allow the disenfranchised credit union members access to normalized bank services at little or no cost including direct deposit and electronic banking, and/or the like

In one aspect, the network 112 can be any suitable wired, wireless, or a combination of both wired (e.g., coax, fiber optic, a combination thereof) and wireless (e.g., Wi-Fi, celluar, 3G, 4G, LTE, WiMax, Bluetooth) communication network. For example, the network can comprise routers, switches, repeaters, network adapters, modems, and/or the like distributed at a variety of local and remote geographic locations. The network 112 can communicatively couple one or more of the debt collection management device, devices managed by stakeholders 102, 104, 106, devices managed by the CUSO 110, devices managed by the credit bureau 108, social media devices, and/or the like.

In one aspect, the social media 114 can comprise social media accounts from consumers, individuals, or other entities. For example, the social media 114 can be stored on a social media device, such as a server, configured to manage a plurality of social media accounts. The accounts can be associated with social media information and/or other data. The social media information can comprise information such as job status, city and state of residence, marital status, asset ownership (e.g., home, vehicles), and/or the identity of individuals that may be able to provide information on the location of the debtor and/or a method of contacting the debtor.

As a further example, social media information can comprise a plurality of interactions between social media users. Interactions can comprise messages, wall postings, likes, media postings, links, status, and/or the like. For example, the social media device can be configured to provide users an account page comprising social media information associated with a user. The social media device can be configured to allow users to access and/or interact with account pages associated with the user and other users. In one aspect, stakeholders 102, 104, 106, other organizations (e.g., credit bureau 108, CUSO 110), and/or members thereof can access account pages associated with one or more account holders of an account in a debt portfolio. The stakeholders 102, 104, 106, other organizations (e.g., credit bureau 108, CUSO 110), or members thereof can retrieve social media information from account pages associated with an account holder. As another example, a device managed by a stakeholder 102, 104, 106 (e.g., debt collection management device), credit bureau 108, CUSO 110, and/or other party can be configured to process the social media information and retrieve information relevant to payment collection on the account of the debt holder.

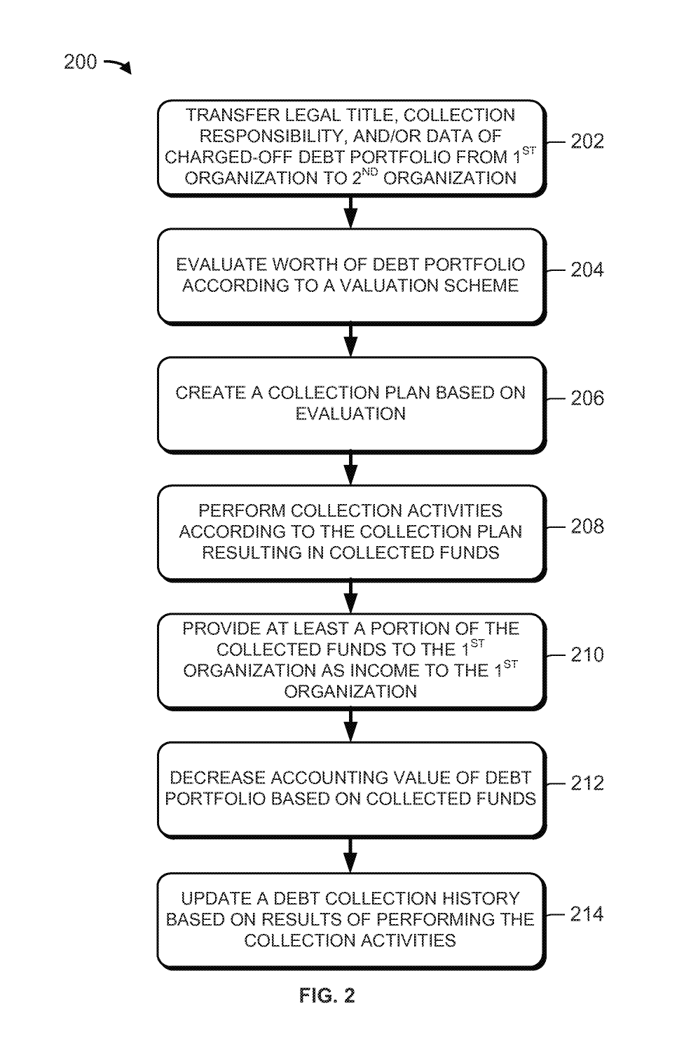

FIG. 2 is a flowchart illustrating a method 200 for implementing an aspect of the technology described herein. For example, the method 200 can represent a method of forming the Credit Union Service Organization (CUSO) that replaces the loss of capital in one or more stakeholder Federal or State Credit Unions with a new positive asset in accordance with Generally Accepted Accounting Principals (GAAP).

At step 202, a first organization (e.g., stakeholder of the second organization) can transfer (e.g., receive, send, accept, request, process) legal title (e.g., right, title, interest), collection responsibility, and/or data of a debt portfolio (e.g. charged off debt portfolio) to a second organization (e.g., CUSO). In one aspect, a computer processor (e.g., of a device managed by a first organization) can transfer the legal title, collection responsibility, and/or data of the debt portfolio. The first organization can claim an equity share in the second organization as a positive financial asset. For example, a device managed by the first organization can receive a message, notification, and/or the like instructing the device to update accounting information to include the positive financial asset. The debt portfolio can comprise one or more debt accounts, such as a charged off debt account. A charged off debt account can be deemed as “uncollectable” for accounting purposes (e.g., by the first organization) and/or an account deemed non-performing. An uncollectable account can be an account that is unlikely to be collected on (e.g., having a probability of being collected that is less than a threshold probability of being collected).

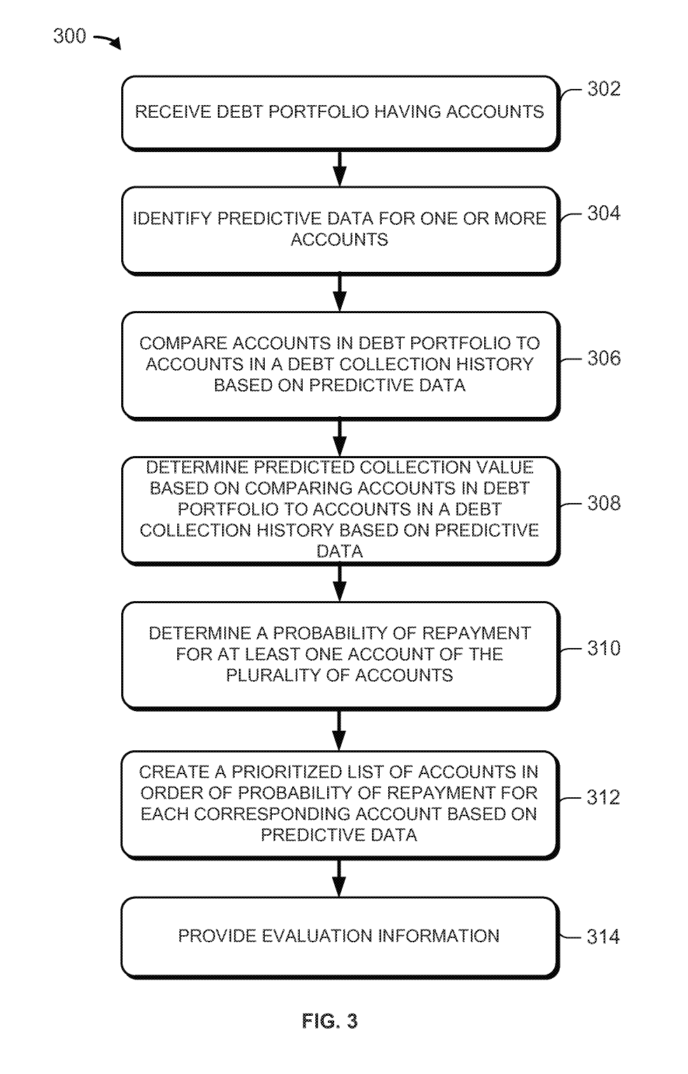

At step 204, the worth of the debt portfolio can be evaluated (e.g., by a computer processor) according to a valuation scheme. For example, evaluating the worth of the debt portfolio according to a valuation scheme can comprise performing one or more steps illustrated in FIG. 3 and the accompanying paragraphs. Evaluating the worth of the debt portfolio can comprise determining a predicted collection value (e.g., collection probability, predicted amount of money collected) based on a comparison of one or more accounts in the debt portfolio to one or more accounts in a debt collection history. In one aspect, evaluating a debt portfolio can comprise one or more evaluation steps, such as an analysis step, pricing step, and the like. An example evaluation comprising an analysis step and a pricing step is described below. The analysis step, pricing step, and/or other steps can be performed by a computer processor.

In one aspect, the evaluation can begin with an analysis step. For example, data for at least a portion (e.g., one or more accounts, and/or information associated with accounts) of a debt portfolio can be received from the stakeholders. The data can comprise loan information, such as name, address history, social security number, current and previous credit scores, prior credit bureau report, copies of the original credit agreement, employment status and information, loan terms, loan balance, any accrued interest, loan payment history, commentary detail of prior conversations, debtor dispute notices, Service Members Credit Relief Act status, cell phone flag, bankruptcy and deceased warning flags, Do Not Call notice activity, and/or the like. The data can be converted into an internal format, such as MS Excel, CSV, comma delimited data string, and/or the like. The data provided by a stakeholder can be input into a debt analysis program (e.g., operated at the debt collection management device). The debt analysis program can be configured to convert external raw data received by the CUSO from stakeholders to an internal format. As explained in further detail herein, the debt analysis program can generate an initial quality assessment of the debt portfolio, preliminary price range, and/or the like. In one aspect, the debt analysis program can instruct a computer processor to perform the analysis step, pricing step, and other analysis. For example, the debt analysis program can organize data for a debt portfolio by account type and original creditor. The debt analysis program can organize and/or analyze the data based on the Federal Reporting statute as defined by the Fair Credit Reporting Act, determining and/or displaying details of the aging by state and the percentages contained in each data subset further broken down and/or organized by the time remaining before the credit reporting period of 6 years and 9 months expires.

In another aspect, the debt analysis program can organize and/or analyze the data by account type, original creditor, the various state statutes as defined by the various state rules limiting the time in which the debtors are subject to litigation for non-payments of the debt, and/or the like. The debt analysis program can determine and/or display details of the aging by the debtor last known state of residence and the percentages contained in one more subsets of the data further organized by the time remaining before the state statute expires, by the balance range (e.g., $1 to $500, $501 to $1,500, 1501 to $2,500, 2501 to $4,000, and greater than $4,000), and/or the like.

In one aspect, the debt analysis program can organize and/or analyze the data by account type and original creditor, determining and/or displaying the last known residence state of the debtor, the date of last payment on the charged off account, the percentage of accounts contained in each state data subset, and/or the like. In another aspect, the debt analysis program can organize the data by account type and original creditor, determining and/or displaying the last known state of residence of the debtor, the date of charge off by the original creditor, the percentage of accounts contained in each state data subset, and/or the like.

In one aspect, evaluating the worth of the debt portfolio according to the valuation scheme can comprise collecting social media information related to a debtor associated with at least one debt account of the plurality of debt accounts. Social media information can be collected from a variety of social media devices and resources, such as Internet forums, weblogs, social blogs, microblogs, wikis, social networks, podcasts, video blogs, photo blogs, rating sites, social bookmarking sites, and/or the like. For example, a debt collection management device or other device (e.g., managed by a debt collection partner stakeholder) can be configured to request social media information from one or more social media devices. For example, the debt collection management device can request one or more social media pages associated with an account holder of an account in a debt portfolio. The debt collection management device can be configured to analyze such pages and select social media information relevant to debt collection. For example, social media information (e.g., relevant to debt collection) can comprise job status, a city and state of residence, marital status, asset ownership (i.e. home or vehicles), and/or the identity of individuals that may be able to provide information on the location and/or a method of getting in contact with the debtor. As a further example, agents (e.g., employees) of the debt collection partner stakeholder or other entity can browse social media information (e.g., account pages hosted by a social media device) and select relevant information for entry into a database (e.g. managed by the debt collection partner stakeholder).

In one aspect, the analysis step can comprise analyzing at least one debt account of a debt portfolio based one or more credit histories. For example, credit history information can be received from major credit bureaus, third-party information providers, and the like. The credit history information can be information associated with an individual (e.g., debtor) associated with an account of the debt portfolio. As a further example, a sample (e.g., statistically valid sample) of accounts in the debt portfolio can be selected and information relevant to the selected accounts can be electronically requested from credit bureau databases. Additionally, statistical matches can be searched for internally, for example, by accessing a historical collections database. Further comparison can be performed based on the credit bureaus' collection recovery score models and national demographic information. In one aspect, the purpose of this step can be to find and append to the accounts additional data fields obtained from these sources.

In one aspect, stakeholders' debt portfolios can be reviewed relating to original issuer underwriting and charge-off policies, availability of back-up documentation, and collection activity to date. Then, this information can be entered into a log for pricing review. Such information can be correlated with information from other debt portfolios, compare with the performance of other original creditor portfolios acquired, used to estimate how much money will be collected over a time period, and/or the like.

As a further illustration, the analysis step can comprise receiving and processing debt portfolio attributes. Example debt portfolio attributes can comprise account attributes related to debt portfolio account status and origination (e.g., attributes 1-6 below), account attributes related to portfolio information (e.g., attributes 7-18 below), and/or account attributes based on internal analysis of data received from the stakeholder (e.g., attributes 19-24 below), and the like. Account attributes can comprise, for example, some or all of the following enumerated attributes: 1. Type of accounts and percentage of portfolio that each type represents (e.g., percentage of credit card loans, percentage of unsecured loans, percentage of consumer goods loans, percentage of auto deficiency loans, and/or percentage of other specified loan); 2. Agency levels of the accounts (e.g., percent zero's, percent one's, percent two's, percent third's, percent quads, and/or percent out of statute): 3. Account origination (e.g., direct mailings, telemarketing campaigns, special programs); 4. General credit ranking accounts received at origination (e.g., A, B, Preferred, Sub-Prime, Mixed etc.); 5. Availability of original credit scores; 6. Charge off policy for the accounts (e.g., 90, 120, 150, 180 recency, other); 7. Accounts with judgments in the portfolio, and availability of applicable documentation; 8. Disputed accounts in the portfolio; 9. Account scoring post-charge off; 10. Accounts subject to legal collection activity: 11. Current practices of the stakeholder for reporting accounts to credit bureaus; 12. Reporting of co-holders, co-makers and/or supplemental account holders to the credit bureaus; 13. Type of documentation available for specified percentage of accounts (e.g., percentage of written applications, percentage of statements of account, percentage of payment histories, percentage of charge slips, percentage of correspondence, percentage of loan agreements, and/or percentage of other type of documentation); 14. Availability of collection activity notes; 15. Number of agencies that have worked the accounts since charge off; 16. Length of placement at each agency; 17. Settlement authority of the agencies; 18. History of mass settlement offers made by either creditor or creditor's agencies; 19. Stratification by-state listing of the accounts by state, number and principal balance; 20. Ratio of In-Statute vs Out of State Statute debt; 21. Average Federal Reporting Statute expiration date under the Fair Credit Reporting Act; 22. Average balance by State by Face Amount (e.g., $1-$500, $501-$1500, $1501-$4000, $4001); 23. Average charge off date; 24. Completeness of the Master File Data (e.g., completeness of Account type, Interest rate, Name, Address, Social Security Number. Co-maker information, Date last paid, Next due, Charge off date, Date of first delinquency, Collateral description (e.g., year, make, model, VIN, other). Date of repossession, Date of sale, and/or Collection commentary detail). Additionally, account attributes can comprise other attributes relevant to evaluating the value of a portfolio. In one aspect, the information and data collected in the analysis step (e.g., information and data related to the debt portfolio attributes) can be stored as debt portfolio account data.

In one aspect, the evaluation of the worth of the debt portfolio can continue with a pricing step. The debt portfolio account data can be applied to a series of regression algorithms using a plurality of account attributes. In one aspect, the pricing step can comprise determining the degree to which a debt portfolio shares significant characteristics with debt portfolios in a debt portfolio history maintained by the CUSO (e.g., second organization), collection partner stakeholder, and/or other collection entity. For example, a debt portfolio history can comprise the entire body of debt portfolios and collections of the CUSO (e.g., second organization), collection partner stakeholder, and/or other debt collection entity for a time period (e.g., since the beginning of debt collection efforts). In one aspect, the most similar debt portfolios in the debt portfolio history can be identified. Based on the purchase and collection results on these similar debt portfolios, an estimated future collection value (EFCV) for a debt portfolio under consideration can be determined (e.g., derived, calculated).

In one aspect, the pricing step can comprise calculating a multivariate linear regression based on the portfolio attributes (e.g., the 24 attributes enumerated herein and/or other attributes). In one aspect, the portfolio attributes can be used in a multivariate linear regression to calculate the EFCV as follows. Historic data indicating performance of portfolios can be continuously updated as accounts are settled. The following linear regression can be calculated based on the portfolio attributes and historic data to form a pricing model: Y=a₀+b₁X₁+b₂X₂+ . . . +bₙXₙ; where, a₀ can represent the y-intercept point; b₁, b₂, . . . bn can represent the slope of X₁, X₂, . . . Xₙ respectively; Y can represent price; X can represent account attribute value (independent variable); and n can represent the number of attributes. As a further illustration, a regression based on 24 attributes (e.g. the 24 attributes described herein) can be of the following form: Y=a₀+b₁X₁+b₂X₂+ . . . +b₂₄X₂₄ where X₁ is value of the first attribute, X₂ is a value of the second attribute. X₂₄ is a value of the twenty fourth attribute. For example, assume the following the attributes: X₁, the number of prior collect agencies, has a value of 1; X₂, the ranking of account quality, has a value of 3; and X₃, the percentage of balances out of statute, has a value of 20 percent. Based on these assumptions, a regression can take the following form: Y=a₀+b₁(2)+b₂(3)+b₃(20%)+ . . . +b₂₄X₂₄.

In one aspect, the multivariate linear regression can determine the slope (b₁, b₂, . . . bₙ) relative to each attribute (X₁, X₂, . . . Xₙ). The Y-intercept can also be calculated using the updated historical data. An R-square test can be performed to determine if the calculated slopes have created a good fit for the data. For example, when the R-square value approaches (e.g. within a predefined threshold of) the value 1, the calculated slopes reach a best fit of predictability for the data.

The slopes and y-intercept can then be substituted into the multivariate linear regression, as well as the attribute values of any new portfolios, and used to determine if the new portfolios are characteristically similar to historical portfolios. For example, data points of the regression calculated for a debt portfolio can be compared to data points of a regression for one or more previous debt portfolios. As another example, the regression calculated for a debt portfolio can be overlaid on a regression of one or more previously collected debt portfolio. As a further illustration, a resulting Y-intercept can indicate the expected price for a new portfolio based on the attributes entered into the pricing model. In one aspect, the coefficients in one or more of the attributes can be tested using standard statistical procedures.

In another aspect, historical collection results can also be continuously updated and reduced to a static pool analysis to determine collection liquidation rates. Static pool analysis can comprise a comparison of the performance of a population of any number of debt portfolios with common attributes (e.g., one or more of the 24 attributes described above). The portfolio acquisition date can be overlaid and aligned with all of the portfolios sampled. The actual monthly cash flow performance can be tracked for one or more debt portfolio starting at month zero. The output of each static pool portfolio can be expressed in dollars and percentages for a given time period (e.g. monthly, quarterly, annually or any time period). The results of static pool analysis can be used to create a collection curve (see Table 1 below) used for modeling expected collections. Debt portfolios purchased within the guidelines of the pricing model perform similarly to other portfolios purchased using the pricing model or used to determine the pricing model. Therefore, the updated historical collection curve regressions can be applied to new portfolios to predict future collections. Table 1 shows example data for a collection curve indicating how much the portfolio can produce collection income over the indicated months. The collection results are shown as a percentage of acquisition cost basis.

TABLE 1

| Transaction | Collection |
|---|---|
| Month | Curve |
| 0 | |
| 1 | 13.051% |
| 2 | 18.896% |
| 3 | 20.025% |
| 4 | 20.533% |
| 5 | 21.510% |
| 6 | 15.723% |
| 7 | 15.499% |
| 8 | 13.435% |
| 9 | 12.251% |
| 10 | 13.606% |
| 11 | 11.341% |
| 12 | 11.140% |
| 13 | 10.586% |
| 14 | 10.403% |
| 15 | 21.782% |
| 16 | 9.031% |
| 17 | 8.193% |
| 18 | 6.795% |
| 19 | 7.606% |
| 20 | 6.525% |
| 21 | 7.615% |
| 22 | 6.691% |
| 23 | 6.950% |
| 24 | 5.521% |
| 25 | 6.209% |
| 26 | 5.162% |
| 27 | 5.204% |
| 28 | 5.763% |
| 29 | 4.651% |
| 30 | 4.271% |
| 31 | 8.065% |
| 32 | 3.969% |
| 33 | 4.068% |
| 34 | 3.618% |
| 35 | 2.896% |
| 36 | 3.277% |
| 37 | 3.062% |
| 38 | 2.399% |
| 39 | 2.460% |
| 40 | 2.911% |
| 41 | 2.182% |
| 42 | 2.686% |
| 43 | 2.019% |
| 44 | 1.521% |
| 45 | 1.434% |
| 46 | 1.577% |
| 47 | 1.430% |
| 48 | 1.572% |
| 49 | 0.990% |
| 50 | 1.094% |
| 51 | 1.051% |
| 52 | 1.084% |
| 53 | 0.859% |
| 54 | 0.867% |
| 55 | 0.949% |
| 56 | 0.856% |
| 57 | 0.501% |
| 58 | 0.947% |
| 59 | 0.638% |
| 80 | 0.590% |
| 61 | 0.625% |
| 82 | 0.525% |
| 63 | 0.579% |
| 84 | 0.700% |
| 65 | 0.377% |
| 86 | 0.713% |
| 67 | 0.803% |
| 68 | 0.441% |
| 69 | 0.553% |
| 70 | 0.333% |
| 71 | 0.395% |
| 72 | 0.428% |
| 73 | 0.408% |
| 74 | 0.569% |
| 75 | 0.497% |
| 76 | 0.345% |
| 77 | 0.496% |
| 78 | 0.328% |
| 79 | 0.610% |
| 80 | 0.228% |
| 81 | 0.156% |
| 82 | 0.130% |
| 83 | 0.228% |
| 84 | 0.319% |
| 85 | 0.219% |
| 86 | 0.546% |
| 87 | 0.214% |
| 88 | 0.343% |
| 89 | 0.175% |
| 90 | 0.557% |
| 91 | 0.155% |
| 92 | 0.133% |
| 93 | 0.134% |
| 94 | 0.207% |
| 95 | 0.227% |
| 96 | 0.173% |
| 97 | 1.083% |
| 98 | 0.202% |
| 99 | 0.430% |
| 100 | 0.177% |
| 101 | 0.159% |
| 102 | 0.166% |
| 103 | 0.160% |
| 104 | 0.600% |
| 105 | 0.193% |
| 106 | 0.295% |
| 107 | 0.171% |
| 108 | 0.248% |
| 109 | 0.157% |
| 110 | 0.266% |
| 111 | 0.271% |
| 112 | 0.124% |
| 113 | 0.150% |
| 114 | 0.059% |
| 115 | 0.137% |
| 116 | 0.076% |
| 117 | 0.069% |
| 118 | 0.099% |
| 119 | 0.051% |
| 120 | 0.043% |

In one aspect, the CUSO portfolio pricing model can be revised monthly using ongoing collections results from new and existing portfolios. Based on a desired rate of return, the model can provide a guide to an appropriate purchase price. For example, if the comparable past portfolios returned a collections performance of X amount (e.g., 3 times the purchase price of the portfolio was collected), a corresponding purchase price can be derived based on a specified target return rate.

At step 206, a collection plan can be created (e.g., by a computer processor) based on the evaluation of the debt portfolio. To optimize collections, one or more methodologies can be used. For example different methodologies may be suitable for different types of accounts can be utilized. Example methodologies can comprise: direct administration with a stakeholder collection partner, outsource to an agency retained by stakeholder collection partner, internet debtor self-settlement, liquidation sale of unwanted portfolios, and the like. The implementation of each technique can be based on the characteristics of the receivables and the stage of the particular account in the account's life-cycle. Thus, various receivables can be rotated among methodologies over the duration of the collections process. These methodologies are explained in greater detail as follows.

In one aspect, a stakeholder collection partner can directly administer the customer accounts. Because the CUSO owns the accounts in the received portfolios, the CUSO has a vested interest not only in exhausting the collection potential, but also in the integrity with which the process is implemented. Therefore, in some cases, in-house collections can be the predominant collection methodology. Ownership of the accounts in the received debt portfolios can also distinguish the CUSO from collections agencies, which collect on a contingent-fee basis for third-parties on debt portfolios assigned to them for a limited amount of time.

As part of the direct administration methodology, internal collectors can be assigned a plurality of accounts. The accounts in the collectors' work queues can be sorted based on analyses of demographic, credit, collection attributes, and similar attributes that indicate which debtors are most likely to pay on the debtors' accounts. In one aspect, the debtor associated with an account can be contacted. On the initial call, the collector can provide a standardized presentation regarding the benefits of resolving the past-due account. In one aspect, the collector can communicate with the debtor to determine the reason for the debtor's default in order to develop a repayment plan that fits the debtor's situation. For example, a common repayment plan can comprise a 20% payment immediately with the balance repaid on a schedule proposed by the collector. At times, with supervisor approval, the collector can offer a reduced lump-sum settlement.

If the collector is unable to contact the debtor (e.g., when the contact information on the account is no longer valid) a skip-tracing process can be initiated. The skip-tracing process can identify new phone, address, employment, or asset information on the debtor. In one aspect, the skip tracing process can comprise retrieving updated information about the debtor from a variety of sources. For example, the skip tracing process can comprise retrieving information from credit bureaus and/or subscription databases, such a Lexis-Nexis® and Accurint®. The retrieved information can be used to uncover current employment, updated addresses, and asset information.

In one aspect, a determination can be made as to the probability that a debtor can repay a loan. The determination can be based on information received from the collector in the telephone call. The determination can also be based on information from the current credit bureau indicating whether any accounts associated with the debtor that were past due are now being paid or settled. When debtors have the likely ability but are unwilling to resolve their obligations, the account can be reviewed for legal action. Depending on the balance due and the applicable state/county collection laws, a decision can be made whether to initiate legal action to judicially collect on the receivable. For example, if the balance is above a certain threshold legal action can be taken. As another example, a determination can be made as to whether a statute of limitations prevents a lawsuit in a particular state. Accordingly, lawsuits can be initiated in jurisdictions where legal action related to an account is not prevented by a statute of limitations.

In some situations, certain collections can be outsourced to third-party collection agencies. For example, accounts in states that require in-state brick and mortar locations to perform collections, high volumes of smaller-balance accounts, and/or selected segments of high-balance accounts can be outsourced to third-party collection agencies. Exemplary collection agencies can be selected based on financial strength, aptitude for collecting similar accounts, collection style, regulatory compliance, and reputation. In one aspect, a particular group of accounts can be rotated among multiple outsource agencies over the life-cycle of the accounts.

In one aspect, a user interface can be provided allowing debtors to self-settle accounts associated with the customer. For example, a debtor can access the user interface through a network, such as the Internet. The user interface can be configured to allow customers to negotiate discounts and repayment schedules without direct interaction from a human collector. The user interface configured for self-settlement can be particularly useful for two types of accounts: smaller-balance accounts where the amount due does not justify the cost of using a human collector, and accounts associated with debtors who are resistant to interacting in person with a human collector.

In one aspect, one or more electronic messages (e.g., emails authorized by opt-in when the debtor established his or her account) can be provided to a debtor that identify the account and invite the debtor to visit the user interface configured for self-settlement, for example, on a website. The debtor can then select among several pre-approved settlements, propose a settlement on the user interface, arrange and complete payments, and/or receive a notification (e.g. letter) indicating new terms for paying the debt or that the debt is paid in part or in full.

In one aspect, any unwanted portfolios can be transferred (e.g., sold, exchanged) to one or more third party buyers. At times it can be suitable to sell selected accounts, such as the remnants of portfolios for which collections have been exhausted by other means. For example, arbitrage opportunities can arise as well, typically from the way portfolios are sold by original creditors. Since buyers usually prefer ease of sale to reputable buyers over maximizing proceeds, accounts can be arbitraged to other buyers. As another example, there can be portfolio subsets that have additional value to niche market participants. For example, a law firm specializing in collections within a given state would be willing to pay a premium for a subset of high-balance accounts domiciled in that state.

At step 208, collection activities can be performed (e.g., by a computer processor) according to the collection plan. For example, the computer processor can generate and/or send a message to a debtor. The computer processor can provide a link to an interface allowing the debtor to accept and/or propose one or more repayment options. The collection activities can result in collected funds. In one aspect, performing the collection activities can comprise negotiating new debt terms on at least one debt account of the plurality of debt accounts. For example, the account debtors can be unable or unwilling to abide by the original debt terms agreed to but are willing to negotiate different repayment terms. The following are examples of negotiated repayment terms: a discount of the unpaid principal balance, waiver of any interest due and owing, release of co-maker or guarantor from the account, longer more flexible repayment terms, a new positive credit reference on the account, terms based on automated Internet settlement system such as the user interface described above, and the like.

At step 210, at least a portion of the collected funds can be provided (e.g., by a computer processor) to the first organization as income to the first organization. For example, a computer processor can provide and/or receive an instruction to transfer a portion of the collected funds to one or more parties. In one aspect, a portion of the funds can be provided to a stakeholder collecting on the accounts (e.g., stake holder collection partner) first to cover the cost of collecting the accounts. The remaining funds can be distributed between the CUSO, the stakeholder collection partner, and the stakeholder that contributed the charged off assets.

At step 212, the accounting value of the debt portfolio can be decreased (e.g., by a computer processor) based on the collected funds. For example, the estimated future net collection value of a given portfolio can be calculated (e.g., by a computer processor). That value can then be discounted (e.g., by a computer processor) to a return on investment of X amount (e.g., between 3 to 6 times return on investment) over Y number of months (e.g., 60) and posted to the capital account of each contributing credit union as a capital asset of the CUSO. If there is more than one contributing stakeholder credit union, each credit union can receive a capital asset value stake as calculated above. In another aspect, each credit union can receive cash flows from collections generated by the portfolios contributed by the credit union. Cash distribution net of collection can be distributed first to stakeholder collection partner to cover the actual cost of collections and the remaining cash can be split between the credit union (e.g., stakeholders thereof) and the stakeholder collection partner as agreed to in advance. In one aspect, each cash distribution made to the contributing credit union(s) can lower the original estimated net future collection value capital asset contribution by that amount.

Under certain accounting rules (e.g., GAAP and AICPA Pronouncement SOP 03-3), the contributing credit union can recognize the revested capital asset in the CUSO as a new asset on the balance sheet of the credit union and can apply a reasonable interest rate to the cash flows received from the capital asset investment. For posting purposes, as the cash flow is received by the contribution credit union, the distribution funds can first be applied to accrued interest with the remainder applied to principal.

At step 214, the debt collection history can be updated based on results of performing the collection activities. For example, the debt collection history can be stored in a database. The database can be provided with additional data indicative of the results of performing the collection activities. The additional data can be formatted according to one or more formats used by the database.

FIG. 3 is a flowchart illustrating a method 300 implementing an aspect of the technology described herein. For example, the method 300 can represent a method of evaluating a debt portfolio. In one aspect, the method 300 can implement one or more steps of the method 200 of FIG. 2. For example, one or more steps of the method 300 can implement step 204 of the method of FIG. 2.

At step 302, a debt portfolio can be received. The debt portfolio can comprise one or more accounts. An account can comprise one or more of, a credit card account, a loan (e.g., auto, home, and the like), a line of credit, and the like.

At step 304, predictive data for the one or more accounts can be identified. For example, at least one credit report related to an account can be received. As a further example, a credit dispute, an application for new credit, and/or a credit search can be identified in the credit report. A credit report update can be received in response to a change in the credit report. Additional predictive data can be received from paid providers such as employment search firms, social media information provided by the debtors themselves, other creditors with recent experience with the debtors, recent cell and landline number changes, recent address changes listed on the Postal Service NCOA, recent bankruptcy listings, recent judgments or liens, and/or the like.

Identifying predictive data can also comprise receiving information from one or more social media accounts associated with the account. For example, identifying predictive data can comprise identifying in the information from the social media accounts a job status, a city and state of residence, marital status, asset ownership (i.e. home or vehicles), and/or the identity of individuals that may be able to provide information on the location and/or a method of getting in contact with the debtor.

At step 306, one or more accounts in the debt portfolio can be compared to one or more accounts in a debt collection history based on the predictive data. For example, account level detail of all collection data on X number of debt portfolios over Y number of years can be collected. The attributes of accounts an incoming portfolio can be compared to the attributes of accounts in a debt portfolio purchased in the past. In one aspect, the compared accounts can be accounts that have at least X amount (e.g., 3 to 6 times) of the acquisition cost collected. If the incoming portfolio attributes statistically match the historically successful portfolios, then the portfolios can be negotiated and acquired. For example, a statistical match can occur when a debt portfolio has one or more same and/or similar attributes (e.g., same value or within a threshold similarity) as a historical debt portfolios that performed at least 3 times (e.g., 3 to 6 times) the acquisition cost.

At step 308, a predicted collection value can be determined based on the comparison of the one or more accounts in the debt portfolio to the one or more accounts in the debt collection history. In one aspect, a regression analysis (e.g., curvilinear regression analysis, multivariate regression analysis) can be performed on X number (e.g., 24) of attributes with separate coefficients as described in further detail herein. R-squared values and confidences can be determined in each attribute to calculate if the portfolio attributes being evaluated are within a threshold value of similarity from the portfolios collected historically (e.g., 1 aggregate standard deviation from the portfolios collected historically). Collection and/or repayment history of one or more portfolios collected historically can be used to determine the probability of repayment.

At step 310, a probability of repayment can be determined for at least one account of the plurality of accounts. For example, a probability of repayment can be determined for each account of the debt portfolio. For example, the probability of repayment can comprise a probability that at least a portion of the balance on the account will be repaid during a time period. The probability of repayment can be determined based on a comparison to one or more similar debt accounts. For example, one or more account attributes can match (e.g., be within a threshold of) values for account attributes of a similar debt accounts. Collection and/or repayment history of the one or more similar debt accounts can be used to determine the probability of repayment.

At step 312, a prioritized list of accounts of the plurality of accounts can be created in order of probability of repayment for each corresponding account based on the predictive data. At step 314, evaluation information can provided. For example, the evaluation information can comprise at least one of the prioritized list of accounts, one or more probabilities of repayment, a predicted collection value and/or the like. In one aspect, the evaluation information can be provided to a debt collector, credit union service organization, and/or the like.

One skilled in the art will appreciate that provided is a functional description and that the respective functions can be performed by software, hardware, or a combination of software and hardware.

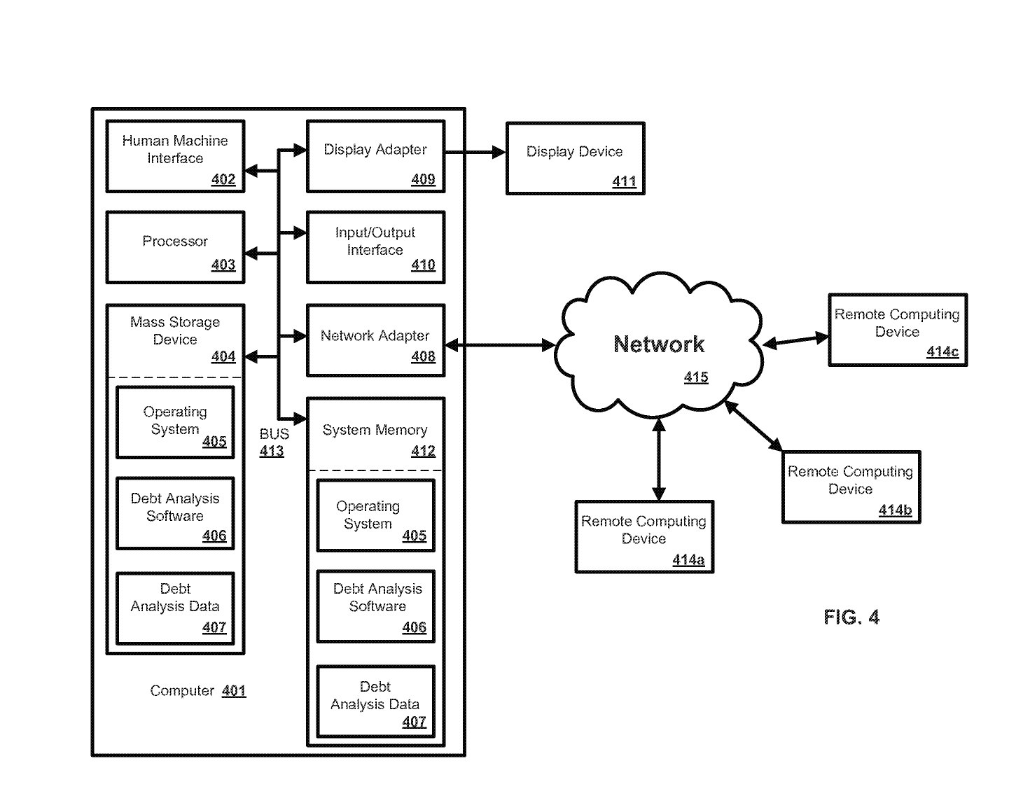

FIG. 4 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 401. The components of the computer 401 can comprise, but are not limited to, one or more processors or processing units 403, a system memory 412, and a system bus 413 that couples various system components including the processor 403 to the system memory 412. In the case of multiple processing units 403, the system can utilize parallel computing.

The system bus 413 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 413, and all buses specified in this description can also be implemented over a wired or wireless network connection and each of the subsystems, including the processor 403, a mass storage device 404, an operating system 405, debt analysis software 406, debt analysis data 407, a network adapter 408, system memory 412, an Input/Output Interface 410, a display adapter 409, a display device 411, and a human machine interface 402, can be contained within one or more remote computing devices 414a,b,c at physically separate locations, connected through buses of this form, in effect implementing a fully distributed system.

In one aspect, the debt analysis software 406 can configure at least one processor 403 for perform one or more operations described herein, such one or more of the steps of the method 200 of FIG. 2, the method 300 of FIG. 3, and/or other operations described herein. For example, the debt analysis software 406 can configure at least one processor 403 for receiving information of a debt portfolio from a first organization for a second organization; evaluating the worth of the debt portfolio according to a valuation scheme; generating a collection plan based on the evaluation; receiving collection data indicative of funds collected by the second organization according to the collection plan; and providing an instruction to transfer at least a portion of the funds collected by the second organization to the first organization as income to the first organization. The information can comprise account data for a plurality of accounts of the debt portfolio. The first organization can claim an equity share in the second organization as a positive financial asset. The debt portfolio can comprise at least one debt account deemed as uncollectable for accounting purposes. In one aspect, evaluating the worth of the debt portfolio according to the valuation scheme can comprise comparing one or more accounts in the debt portfolio to one or more accounts in a debt collection history. In another aspect, evaluating the worth of the debt portfolio according to the valuation scheme can comprise receiving credit information related to the debt portfolio from a credit agency. The evaluation can be based on the credit information. In one aspect, generating the collection plan based on the evaluation can comprise creating a prioritized list of accounts of the plurality of accounts of the debt portfolio in order of probability of repayment based on the evaluation. In one aspect, debt analysis data 407 can comprise account data, collection data, social media data, debt portfolio information, collection plans, credit information, debt collection history, evaluated worth of a debt portfolio, and/or the like.

The computer 401 typically comprises a variety of computer readable media. Exemplary readable media can be any available media that is accessible by the computer 401 and comprises, for example and not meant to be limiting, both volatile and non-volatile media, removable and non-removable media. The system memory 412 comprises computer readable media in the form of volatile memory, such as random access memory (RAM), and/or non-volatile memory, such as read only memory (ROM). The system memory 412 typically contains data such as debt analysis data 407 and/or program modules such as operating system 405 and debt analysis software 406 that are immediately accessible to and/or are presently operated on by the processing unit 403.

In another aspect, the computer 401 can also comprise other removable/non-removable, volatile/non-volatile computer storage media. By way of example, FIG. 4 illustrates a mass storage device 404 which can provide non-volatile storage of computer code, computer readable instructions, data structures, program modules, and other data for the computer 401. For example and not meant to be limiting, a mass storage device 404 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 404, including by way of example, an operating system 405 and debt analysis software 406. Each of the operating system 405 and debt analysis software 406 (or some combination thereof) can comprise elements of the programming and the debt analysis software 406. Debt analysis data 407 can also be stored on the mass storage device 404. Debt analysis data 407 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computer 401 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the processing unit 403 via a human machine interface 402 that is coupled to the system bus 413, but can be connected by other interface and bus structures, such as a parallel port, game port, an IEEE 1394 Port (also known as a Firewire port), a serial port, or a universal serial bus (USB).

In yet another aspect, a display device 411 can also be connected to the system bus 413 via an interface, such as a display adapter 409. It is contemplated that the computer 401 can have more than one display adapter 409 and the computer 401 can have more than one display device 411. For example, a display device can be a monitor, an LCD (Liquid Crystal Display), or a projector. In addition to the display device 411, other output peripheral devices can comprise components such as speakers (not shown) and a printer (not shown) which can be connected to the computer 401 via Input/Output Interface 410. Any step and/or result of the methods can be output in any form to an output device. Such output can be any form of visual representation, including, but not limited to, textual, graphical, animation, audio, tactile, and the like.

The computer 401 can operate in a networked environment using logical connections to one or more remote computing devices 414a,b,c. By way of example, a remote computing device can be a personal computer, portable computer, a server, a router, a network computer, a peer device or other common network node, and so on. Logical connections between the computer 401 and a remote computing device 414a,b,c can be made via a local area network (LAN) and a general wide area network (WAN). Such network connections can be through a network adapter 408. A network adapter 408 can be implemented in both wired and wireless environments. Such networking environments are conventional and commonplace in offices, enterprise-wide computer networks, intranets, and the Internet 415.

For purposes of illustration, application programs and other executable program components such as the operating system 405 are illustrated herein as discrete blocks, although it is recognized that such programs and components reside at various times in different storage components of the computing device 401, and are executed by the data processor(s) of the computer. An implementation of debt analysis software 406 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology. CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method of forming an organization, comprising:
transferring legal title of a charged off debt portfolio from a first organization to a second organization, wherein the debt portfolio comprises a plurality of debt accounts, and wherein the first organization claims an equity share in the second organization as a positive financial asset;
evaluating worth of the debt portfolio according to a valuation scheme;
creating a collection plan based on the evaluation;
performing collection activities according to the collection plan resulting in collected funds; and
providing at least a portion of the collected funds to the first organization as income to the first organization.

2. The method of claim 1, wherein the debt portfolio comprises at least one debt account deemed as uncollectable for accounting purposes.

3. The method of claim 1, wherein evaluating the worth of the debt portfolio comprises determining a predicted collection value based on a comparison of one or more accounts in the debt portfolio to one or more accounts in a debt collection history.

4. The method of claim 3, further comprising updating the debt collection history based on results of performing the collection activities.

5. The method of claim 1, further comprising decreasing an accounting value of the debt portfolio based on the collected funds.

6. The method of claim 1, wherein performing collection activities according to the collection plan resulting in collected funds comprises negotiating new debt terms on at least one debt account of the plurality of debt accounts.

7. The method of claim 1, wherein evaluating the worth of the debt portfolio according to the valuation scheme comprises collecting social media information related to a debtor associated with at least one debt account of the plurality of debt accounts.

8. A method of evaluating a debt portfolio, comprising:
receiving a debt portfolio having a plurality of accounts;
identifying predictive data for one or more of the plurality of accounts;
comparing one or more accounts in the debt portfolio to one or more accounts in a debt collection history based on the predictive data; and
determining a predicted collection value based on the comparing the one or more accounts in the debt portfolio to the one or more accounts in the debt collection history.

9. The method of claim 8, wherein identifying predictive data comprises receiving at least one credit report related to an account.

10. The method of claim 9, wherein identifying predictive data comprises identifying in the credit report at least one of a credit dispute, an application for new credit, and a credit search.

11. The method of claim 9, wherein identifying predictive data comprises receiving a credit report update in response to a change in the credit report.

12. The method of claim 8, wherein identifying predictive data comprises receiving information from one or more social media accounts associated with the account.

13. The method of claim 12, wherein identifying predictive data comprises identifying in the social media accounts at least one of a job status, city of residence, state of residence, marital status, asset ownership, and identity of individuals associated with the debtor.

14. The method of claim 8, further comprising:
determining a probability of repayment for at least one account of the plurality of accounts; and
creating a prioritized list of accounts of the plurality of accounts in order of the probability of repayment for each corresponding account based on the predictive data.

15. A system, comprising:
a memory having computer-executable instructions encoded thereon; and
at least one processor functionally coupled to the memory and configured, by the computer-executable instructions, for,
receiving information of a debt portfolio from a first organization for a second organization, wherein the information comprises account data for a plurality of accounts of the debt portfolio,
evaluating the worth of the debt portfolio according to a valuation scheme,
generating a collection plan based on the evaluation,
receiving collection data indicative of funds collected by the second organization according to the collection plan, and
providing an instruction to transfer at least a portion of the funds collected by the second organization to the first organization as income to the first organization.

16. The system of claim 15, wherein the first organization claims an equity share in the second organization as a positive financial asset.

17. The system of claim 15, wherein evaluating the worth of the debt portfolio according to the valuation scheme comprises comparing one or more accounts in the debt portfolio to one or more accounts in a debt collection history.

18. The system of claim 15, wherein evaluating the worth of the debt portfolio according to the valuation scheme comprises receiving credit information related to the debt portfolio from a credit agency, wherein the evaluation is based on the credit information.

19. The system of claim 15, wherein the debt portfolio comprises at least one debt account deemed as uncollectable for accounting purposes.

20. The system of claim 15, wherein generating the collection plan based on the evaluation comprises creating a prioritized list of accounts of the plurality of accounts of the debt portfolio in order of probability of repayment based on the evaluation.
